(19) United States
(12) Patent Application Publication
(10) Pub. No.: US 2006/0093059 A1
(43) Pub. Date: May 4, 2006

(54) Interleaver and de-interleaver systems

(75) Inventor: Dimitrios Skraparlis, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/254,784

(22) Filed: Oct. 21, 2005

(30) Foreign Application Priority Data
Nov. 1, 2004 (GB) 0424116.2

(51) Int. Cl. H04L 1/02

(52) U.S. Cl. 375/267

(57) ABSTRACT

This invention relates to bit interleaver and de-interleaver apparatus, methods and processor control code for use in MIMO (Multiple-input multiple-output) communications systems, in particular MIMO systems employing OFDM (orthogonal frequency division multiplexing).

We describe an interleaver for a MIMO OFDM communications system having a plurality of transmit antennas, said interleaver being configured to interleave a block of N data bits comprising data for a plurality of OFDM symbols, each OFDM symbol being defined by a block of N_{cbps} bits, by implementing first and second interleaving functions wherein at least one of said interleaving finctions is configured to interleave data bits between said blocks of N_{cbps} bits. We also describe a corresponding de-interleaver and related interleaving and de-interleaving methods.

This invention relates to bit interleaver and de-interleaver apparatus, methods and processor control code for use in MIMO (Multiple-input multiple-output) communications systems, in particular MIMO systems employing OFDM (orthogonal frequency division multiplexing).

A bit interleaver is a hardware structure commonly used with error correction codes such as convolutional codes to counteract the effect of burst errors. Burst errors occur on some physical channels such as fading channels which are typical for both indoor and outdoor wireless environments. In such channels, if the channel is in a deep fade, caused by multipath propagation and/or Doppler spread, a large number of bit errors at the receiver occur in sequence. A bit interleaver takes the bits to be transmitted as input and outputs the same bits in a different sequence. The inverse operation (de-interleaving) is performed at the receiver and re-arranges the bits to the correct order. The effect of interleaver is that the location of bit errors looks random and is distributed over the whole bitstream. In other words, it avoids a local concentration of many errors by dispersing the errors over the whole bitstream. This facilitates error correction and detection and is commonly used in communication systems such as 802.11a.

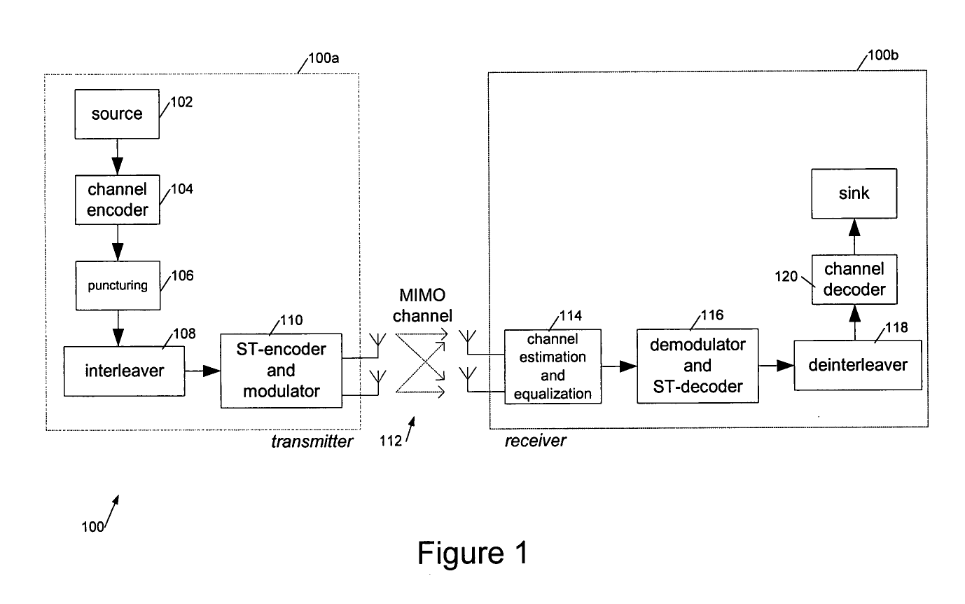

FIG. 1 shows a typical system view of a MIMO communications system 100 comprising a transmitter 100a and receiver 100b, employing error correction and interleaving. A transmitter 100a comprises a source 102 that generates bits, which are then channel encoded 104 and rate-matched using, for example, a convolutional encoder with rate ½ followed by puncturing 106. Puncturing involves removing selected code bits so that they are not transmitted, and is used to reduce the rate of the convolutional encoder to a desired rate, for example ½, ⅔, ¾ of the code rate (as specified in IEEE Std. 802.11a-1999), thus changing the error correction capabilities without changing the overall code structure. An interleaver 108 re-arranges the bit positions of the encoded bits and then the new stream of bits is mapped into space (across antennas), time and frequency (across subcarriers, in the case of OFDM systems) by a ST-encoder (space-time encoder) and modulator 110 and transmitted over the physical MIMO channel 112. The corresponding receiver 100b includes channel estimation and equalisation 114 to estimate and equalise the MIMO channel. For example a training sequence can be transmitted from each transmit antenna in turn, each time listening on all the receive antennas to characterise the channels from that transmit antenna to the receive antennas; some particularly advantageous training sequences are described in the Applicant's UK patent application no. 0222410.3 filed on 26 Sep. 2002 (TRLP034). This is followed by a decoder 116, which performs the inverse process of demodulating and ST-decoding the received transmissions. The resulting bits are then de-interleaved 118 and decoded 120 using, for example, a Viterbi decoder, producing an estimation of the original bits that the transmitter source generated.

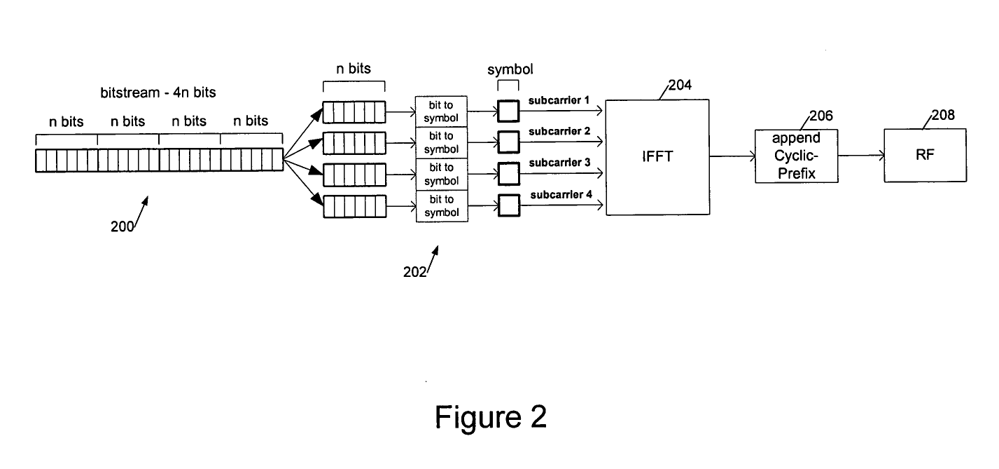

The 802.11a standard uses the OFDM technique, which transmits 52 equally spaced (over frequency) orthogonal subcarriers (48 with 4 pilot subcarriers, out of 64 possible subcarrier slots). FIG. 2 illustrates diagrammatically an example of how data bits are mapped to subcarriers. An input bitstream 200 of 4n bits is divided into four sets of n bits each and then mapped 202 to respective constellation symbols for (in this simplified illustration, four) OFDM subcarriers. The four subcarriers 1-4 are used as inputs to an IFFT block 204 which outputs an OFDM symbol to which is appended a cyclic prefix 206 to mitigate inter-symbol interference due to multipath, prior to rf transmission 208. This process is typical to an OFDM system and is only mentioned here in order to facilitate the description of the invention.

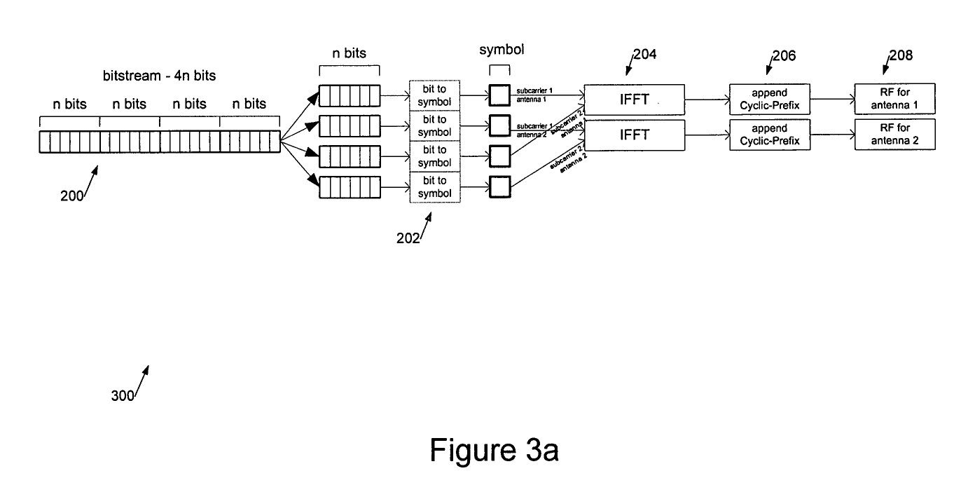

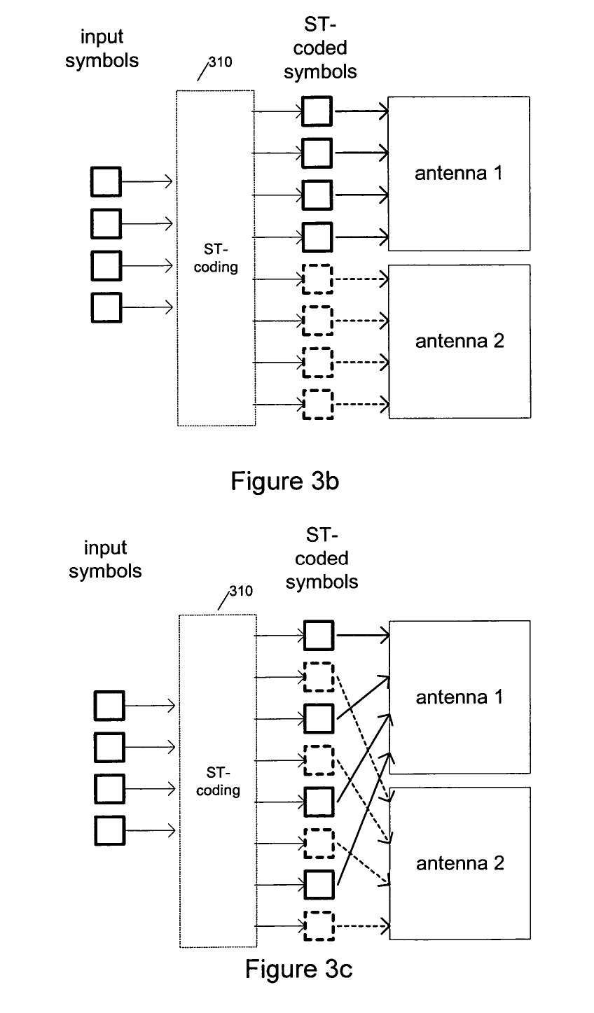

FIG. 3a shows a similar OFDM system 300 employing MIMO, in which like elements to those of FIG. 2 are indicated by like reference numerals. In the MIMO OFDM system 300 the bits are converted to symbols and, in the case of for example two transmit antennas, every second symbol is used as an input to the IFFT block 204 for the corresponding antenna 208 (there is one IFFT block per antenna). In other words, symbols 1,3,5,7, . . . are assigned to antenna 1, while symbols 2,4,6,8, . . . are assigned to antenna 2. FIG. 3c shows a portion of a modified version of the system of FIG. 3a in which an ST-coder 310 is employed to apply ST-coding to the OFDM input symbols prior to transmission.

FIGS. 3a and 3c show MIMO systems that map symbols to antennas in a “multiplexing” fashion. Thus referring to FIG. 3c, after Space-Time coding, it can be seen that the resulting symbols are multiplexed to the transmit antennas. The inverse process is performed at the receiver. This “multiplexing” method, as shown in the simplified examples of FIGS. 3a and 3c, is the preferred method of assigning symbols to antennas for the later described embodiments of the invention. FIG. 3b shows an alternative, “block” method of assigning symbols to antennas in which, for example, the first two symbols are assigned to antenna 1, the second two symbols are assigned to antenna 2, and so forth.

As explained above, the performance of communication systems employing forward error correction (FEC) codes can be improved by bit interleaving, which involves creating a permutation of the coded bit stream so that bits that were adjacent to each other when leaving the encoder are separated during transmission over the channel. It is common to define such a permutation mathematically.

It is helpful for understanding the invention to review the interleaving and de-interleaving processes defined in the IEEE Standard 802.11a, Wireless LAN Medium Access Control (MAC) and Physical Layer (PHY) specifications High-speed Physical Layer in the 5 GHz Band, 1999 (hereby incorporated by reference). The interleaver can be summarised as a two stage interleaver designed to ensure that consecutive bits are mapped to every third OFDM subcarrier (first stage) and also mapped to different bit positions in the constellation (second stage). Other OFDM-based wireless standards such as IEEE802.11g and Hiperlan/2 (ETSI TS 101 475 (BRAN), HIPERLAN TYPE 2, Physical (PHY) Layer, 2001) use the same interleaving scheme.

The first 802.11a interleaver stage comprises a first permutation defined by the rule:
π(i)=(Ncbps/16)(i mod 16)+floor(i/16)
where i=0 . . . Ncbps−1 is the position of the input bit and π(i) is its position after the permutation, and floor(parameter) is the largest integer not exceeding the parameter.

This first stage of the 802.11a interleaver is the so-called classical “LR/TB” block interleaver described in, for example Section 3.2 of “Turbo Coding” by Chris Heegard and Stephen B. Wicker, Kluwer Academic Publishers, 1999. Here LR/TB stands for Left-Right/Top-Bottom, which describes the way the bits are written and read during the operation of the interleaver: bits are read-in as rows of a 2-D matrix and read-out as columns.

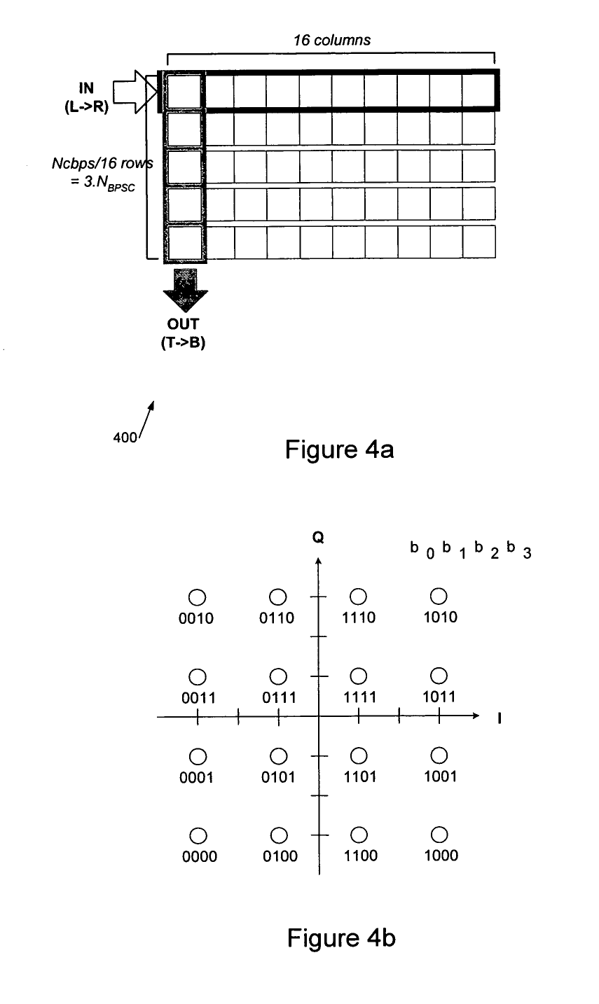

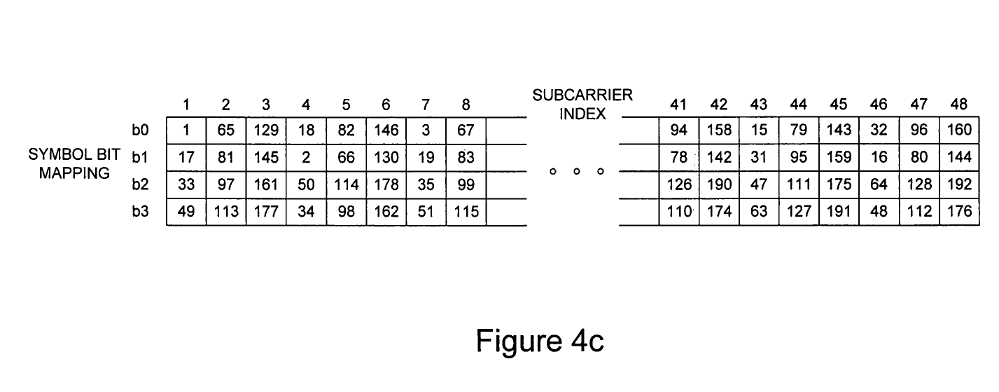

FIG. 4a shows the structure 400 of such a classical Left-Right/Top-Bottom block interleaver. This comprises a 2-D matrix with Ncbps/16 rows and 16 columns where Ncbps is the number of bits per OFDM symbol (equivalent to the value of 4*n in FIGS. 2 and 3) and N_{BPSC} is the number of bits per subcarrier (corresponding to “n” in FIGS. 2 and 3).

This interleaver can be rewritten in mathematical terms:
π(i)=16·i mod (Ncbps−1), i=0 . . . Ncbps−1, π(Ncbps−1)=Ncbps−1
where i is the position of the input bit. This position is multiplied by 16, the result is then divided by (Ncbps−1), and the resulting remainder is the new bit position π(i). This is equivalent to taking every 16^{th} bit and placing them to adjacent positions.

The second 802.11a interleaver stage comprises a second permutation defined by the rule:
π(i)=s*floor(i/s)+(i+Ncbps−floor(16*i/Ncbps)) mod s
where i=0 . . . Ncbps−1 is the position of the input bit and π(i) is its position after the permutation. Here s is dependent on the constellation size—it is 3 for 64-QAM, 2 for 16-QAM, and 1 for QPSK and for BPSK or, more generally, s=max (N_{BPSC}/2; 1).

In this second stage, the bitstream is processed in groups of s bits and a cyclic bit shifting is performed (per group), having a shift step=t mod s bits (t=0 . . . 15, increasing by 1 in every Ncbps/16 bits). This maps bits to constellation bit positions of alternating reliability.

This can be understood by considering the example of FIG. 4b, which shows a graph of the 16 QAM (Quadrature Amplitude Modulation) constellation. In this figure dots plot the 16 symbols with respect to their in-phase (I) and quadrature (Q) components and the symbols are mapped to values between 0000(binary) and 1111(binary) of a binary number b₀b₁b₂b₃.

In the general case, for a constellation that conveys M bits per symbol, denoted as the vector [b₀,b₁, . . . ,b_{M-1}], the reliability of a bit being successfully received can vary according to its position within the vector and the reliability of each bit position is dependent upon the exact bit-to-symbol mapping. Reliability depends on the Euclidean distance between symbols (as plotted on the graph of quadrature component against in-phase component of FIG. 4b) and whether the symbols represent bit vectors with bits of common value. For example a certain transmitted symbol is in many cases most likely to be wrongly detected as one of its closest neighbouring symbols. If all neighbouring symbols represent the same bit value in a particular bit position then this bit position will be more reliable than if the bit values are different.

In the allocation illustrated in FIG. 4b, the bit mapping results in bits b₀ and b₂ having equal reliability, and bits b₁ and b₃ having equal reliability. The process of distinguishing between b₀=0 and b₀=1 is one of determining whether the in-phase component of the received signal is positive or negative. Similarly, the process of distinguishing between b₂=0 and b₂=1 is one of determining whether the quadrature component of the received signal is positive or negative. On the other hand, the process of determining the value of b₁ or b₃ is based on the amplitude of the in-phase or quadrature components, respectively.

FIG. 4c shows a diagram illustrating bit allocations for an IEEE 802.11a interleaver for a single OFDM symbol with 48 subcarriers in a system using 16 QAM modulation.

It can be seen that adjacent bits are allocated to every third subcarrier and that they alternate between bit positions b₀ and b₁ or between b₂ and b₃. The 802.11a interleaver is designed for a block size equal to the number of coded bits that are conveyed in each OFDM symbol, which can vary since 802.11a systems allow for adaptive modulation and coding.

We next review the IEEE 802.11a de-interleaver.

In de-interleaving at the receiver, the inverse process interleaving is performed. This begins with:
π⁻¹(i)=s*floor(i/s)+(i+floor(16*i/Ncbps)) mod s, i=0 . . . Ncbps−1

This stage is the inverse of the second interleaving stage. Then the inverse of the first interleaving stage is performed:
π⁻¹(i)=16*i−(Ncbps−1)*floor(16*i/Ncbps), i=0 . . . Ncbps−1

This second step is equivalent to implementing a classical “TB/LR” block deinterleaver, where TB/LR stands for Top-Bottom/Left-Right, which describes the way the bits are written and read during the operation of the interleaver. Bits are read-in as columns of a 2-D matrix and read-out as rows (although it will be appreciated that the labelling of rows and columns for the 2D matrix is arbitrary).

The structure of this deinterleaver is the same as the one shown in FIG. 4a, with the only difference of the way the bits are loaded-in and read-out. The interleaving matrix is still a 2-D matrix with Ncbps/16 rows and 16 columns. This enables a single hardware resource for the second stage of the intereleaver to be used for de-interleaving too (only the loading/read-out procedure is different).

An architecture for a block interleaver in which data is written and read word-by-word rather than bit-by-bit is described in Eric Tell and Dake Liu, “A Hardware Architecture for a Multi Mode Block Interleaver”, Proc. of the International Conference on Circuits and Systems for Communications (ICCSC), Moscow, Russia, June 2004.

Interleaving design depends on the application and thus specific designs are desirable for MIMO systems, in particular MIMO OFDM systems employing convolutional coding.

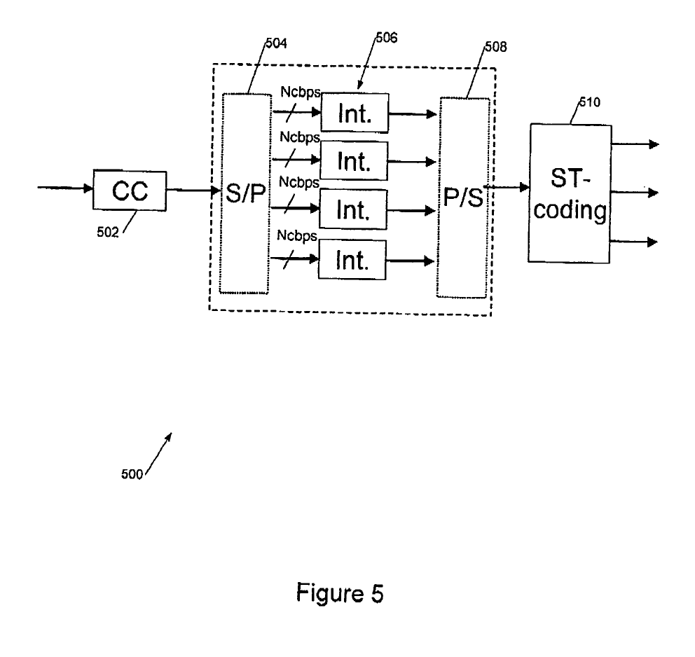

All 802.11a systems are single antenna systems, and therefore the interleaver interleaves bits transmitted over the single antenna. In a case where multiple antennas are employed (MIMO), one can imagine extending the 802.11a interleaver by separating the input stream into a number of streams equal to the number of antennas and operating the 802.11a interleaver on each stream separately; this is illustrated diagrammatically in FIG. 5.

FIG. 5 shows one possible MIMO OFDM interleaving system 500 in which a convolutional coder CC 502 encodes the input bits (and also performs puncturing) and then a Serial to Parallel function 504 splits the bits into blocks of Ncbps bits, which are then each separately interleaved 506 according to the 802.11a interleaver system described above. The resulting blocks of bits are then concatenated back to a single long bit stream by a parallel-to-serial converter 508, and this bit stream is then Space-Time encoded 510 and mapped to antennas according to the “block” method of FIG. 3b and transmitted.

De-interleaving (not shown in FIG. 5) may be performed in similar, but complementary manner: after ST-decoding at the receiver, the bit stream is again grouped into Ncbps blocks of bits, and the de-interleaver operates on each block separately.

However the inventor has simulated the performance of this method and it appears that it does not yield good results (as illustrated later). We have previously described a number of improved systems in the Applicant's earlier related UK patent application number no. 0413687.5 filed 18 Jun. 2004. However alternative improved interleaving methods and apparatus for MIMO systems, and corresponding de-interleaving methods and apparatus, would also be useful.

According to a first aspect of the present invention there is therefore provided an interleaver for a MIMO OFDM communications system having a plurality of transmit antennas said interleaver being configured to interleave a block of N data bits comprising data for a plurality of OFDM symbols, each OFDM symbol being defined by a block of N_{cbps} bits, by implementing first and second interleaving functions wherein at least one of said interleaving functions is configured to interleave data bits between said blocks of N_{cbps} bits.

In embodiments the effect of interleaving between blocks of data bits corresponding to OFDM symbols is to interleave across antennas. Thus preferably one or both of the interleaving functions interleave across space, that is between antennas.

Preferably the interleaver comprises two stages, a first stage to implement the first interleaving function followed by a second stage to implement the second interleaving function. However in embodiments these two stages may be combined and the first and second interleaving functions implemented together, for example by means of a single look-up table (LUT).

In one embodiment the first stage of interleaving is considered to interleave over a complete block of N data bits, both across antennas and across frequency (that is across subcarriers of the OFDM symbols). Preferably the second stage also interleaves over a complete block of N data bits, and may be configured to implement a cyclical bit shift to map adjacent bits alternately to more significant and less significant bits of the modulation constellation. The cyclical bit shift may, for example, comprise a shift step which varies from a minimum value to a maximum value over substantially the length of the whole block (that is the shift increasing by 1 for successive integer fractions of the block of N bits). In this way the second stage of the interleaver may conveniently be implemented using modified 802.11a hardware or program code.

Returning again to the first interleaving stage or, more particularly to the first interleaving function, this may be configured to interleave the block of N data bits such that pairs of bits c bits apart, where c is greater than 1 and preferably equal to 16, are mapped to adjacent bits. Thus in some embodiments an interleaving function similar to that of a first stage 802.11a interleaver may be implemented, but over the complete block of N data bits. This simplifies implementation of embodiments of an interleaver according to aspects of the invention whilst maintaining an interleaving across antennas.

In other embodiments, however, the first stage of the interleaver (or the first interleaving function) may implement a first stage 802.11a interleaver for each of block bits comprising an OFDM symbol (across frequency but not across antennas) and then the results of this may be concatenated, with additional interleaving, to perform across-antenna interleaving. In this way conventional 802.11a hardware or program code may be employed and the output streams combined to interleave across antennas, thus simplifying implementation of the first stage of an interleaver embodying aspects of the present invention.

Some preferred embodiments of the interleaver may be implemented using a matrix memory block configured to store an interleaving matrix with data being written to the matrix row-by-row and read from the matrix column-by-column (or vice versa). This is a conventional approach as previously described with reference to FIG. 4a but to implement the first stage of the interleaver the conventionally interleaved column data can be concatenated as it is read from the matrix column-by-column to provide across-antenna interleaving. More particularly a set of matrices implemented sequentially or in parallel may be used to interleave across frequency (subcarriers) and then corresponding columns in these matrices may be read and concatenated and then written as rows into an additional leaving matrix. Still more particularly each column may be written as a separate row, these rows being aligned “underneath” one another to provide a set of further columns (the number of columns in the set being equal to the number of bits in each column) and then these columns-written-as-rows may themselves be read as columns to provide additional interleaving. A complementary procedure (and means for implementing the procedure) may be employed or de-interleaving.

Any of the above described alternatives first interleaving stages may be employed with any of the above-described second interleaving stages.

In another arrangement conventional first and second 802.11a interleaving stages are combined and implemented as the first interleaver stage (or first interleaving function) on a per antenna basis. The second interleaver stage (or second interleaving function) may then combine (and interleave) the result of the first interleaving stage from across-antenna interleaving. This configuration allows the use of a single look up table interleaver for each antenna separately followed by a step of interleaving the bits across space.

One or both stages of the interleaver may be implemented in either dedicated hardware or using a software controlled processor in conjunction with appropriate processor control code, or using a bit addressable memory and a look up table in ROM, for using any combination of these techniques. In preferred embodiments of the invention which employ a matrix memory block implementation using a processor is straightforward since, in essence, all that is required is a series of write and read instructions to appropriate addresses.

The invention further provides a MIMO transmitter including an interleaver as described above, for transmitting using the plurality of transmit antennas, the interleaver being configured to interleave the block of data for a plurality of OFDM symbols across space as well, preferably, across OFDM subcarriers. Preferably the transmitter comprises a convolutional coder and preferably the interleaver is configured to interleave convolutionally coded data for transmission.

The invention further provides a method of interleaving data for a MIMO OFDM communications system having a plurality of transmit antennas, the method comprising: inputting a block of N data bits comprising data for a plurality of OFDM symbols, each OFDM symbol being defined by a block of N_{cbps} bits; implementing a first interleaving function on said block of N data bits, implementing a second interleaving function on said block of N data bits; and outputting data interleaved by said first and second interleaving functions; wherein at least one of said interleaving functions is configured to interleave data bits between said blocks of N_{cbps} bits.

In one embodiment of the method the first interleaving function interleaves across frequency (for example conventionally) and across space, and preferably the second interleaving function then interleaves across the block on N data bits (interleaving between OFDM symbols). In another embodiment of the method the first interleaving function comprises two conventional interleaving stages and is implemented per antenna, and the second interleaving function interleaves across space. In this embodiment the two first stage interleaving functions may comprise a first permutation to modulate adjacent bits onto non-adjacent OFDM subcarriers and a second permutation to map adjacent bits onto constellation bits of different significance. In another arrangement the first interleaving function interleaves across frequency and space by implementing a single permutation across data bits for a plurality of OFDM symbols for transmission by a plurality of different transmit antennas.

The invention further provides an interleaver for a MIMO OFDM communications system having a plurality of transmit antennas, the interleaver comprising: means for inputting a block of N data bits comprising data for a plurality of OFDM symbols, each OFDM symbol being defined by a block of N_{cbps} bits; means for implementing a first interleaving function on said block of N data bits; means for implementing a second interleaving function on said block of N data bits; means for outputting data interleaved by said first and second interleaving functions; and wherein at least one of said interleaving functions is configured to interleave data bits between said blocks of N_{cbps} bits.

The further provides means for implementing a complementary de-interleaver to the above described interleavers, and complementary de-interleaving methods.

Broadly speaking each function is replaced by its inverse or complementary function or mapping to provide a complementary de-interleaver or de-interleaving method. Thus the invention contemplates making such substitutions in the above described interleavers and interleaving methods.

Thus in a complementary aspect the invention further provides a de-interleaver for a MIMO OFDM communications system having a plurality of transmit antennas, said de-interleaver being configured to de-interleave N interleaved data bits comprising data for a plurality of transmitted OFDM symbols, each OFDM symbol being defined by N_{cbps} interleaved bits, by implementing second and first de-interleaving functions, wherein at least one of said de-interleaving functions is configured to de-interleave data permuted across said N data bits to provide a plurality of blocks of N_{cbps} bits each corresponding to a said OFDM symbol.

Such a de-interleaver may be implemented using a matrix memory block, writing in the data to be de-interleaved column-by-column and reading the data from the matrix row-by-row. Complementary de-interleaving structures to those described above for across space interleaving may also be implemented if needed.

The invention further provides a complementary method of de-interleaving data in a MIMO OFDM communications system, the method comprising: inputting N interleaved data bits comprising data for a plurality of transmitted OFDM symbols, each OFDM symbol being defined by N_{cbps} interleaved bits; implementing a second de-interleaving function on said N data bits; implementing a first de-interleaving function on said N data bits; and outputting data de-interleaved by said first and second de-interleaving functions; wherein at least one of said de-interleaving functions is configured to de-interleave data permuted across said N data bits to provide a plurality of blocks of N_{cbps} bits each corresponding to a said OFDM symbol.

The invention further provides a de-interleaver for de-interleaving data in a MIMO OFDM communications system, the de-interleaver comprising: means for inputting N interleaved data bits comprising data for a plurality of transmitted OFDM symbols, each OFDM symbol being defined by N_{cbps} interleaved bits; means for implementing a second de-interleaving function on said N data bits; means for implementing a first de-interleaving function on said N data bits; and means for outputting data de-interleaved by said first and second de-interleaving functions; wherein at least one of said de-interleaving functions is configured to de-interleave data permuted across said N data bits to provide a plurality of blocks of N_{cbps} bits each corresponding to a said OFDM symbol.

The invention further provides a receiver including a de-interleaver as described above, and a receiver configured to operate in accordance wit a de-interleaving method as described above.

The invention further provides a MIMO OFDM signal comprising data interleaved by the method or apparatus described above.

The above-described interleavers and de-interleavers, and interleaving and de-interleaving methods may be implemented using processor control code. This code may be provided on a data carrier such as a disk, CD- or DVD-ROM, programmed memory such as read-only memory or EEPROM (Firmware), or on a data carrier such as optical or electrical signal carrier. For many applications embodiments of the above-described interleavers, de-interleavers will be implemented on a DSP (Digital Signal Processor), ASIC (Application Specific Integrated Circuit) or FPGA (Field Programmable Gate Array). Thus code (and data) to implement embodiments of the invention may comprise code in a conventional programming language such as C, or microcode. However code to implement embodiments of the invention may alternatively comprise code for setting up or controlling an ASIC or FPGA, or code for a hardware description language such as Verilog (Trade Mark), VHDL (Very high speed integrated circuit Hardware Description Language) or SystemC. As the skilled person will appreciate such code and/or data may be distributed between a plurality of coupled components in communication with one another, for example on a network.

A communications system may be provided comprising a transmitter apparatus in accordance with any aspect of the invention and an appropriately configured receiver.

These and other aspects, preferred features and advantages of the invention will now be further described, by way of example only, with reference to the accompanying drawings, in which:

FIG. 1 shows a typical MIMO communications system employing error correction and interleaving;

FIG. 2 illustrates diagrammatically an example of how data bits may be mapped to subcarriers in a conventional single transmit antenna OFDM communications system;

FIGS. 3a to 3c show, respectively, first multiplexing, block, and second multiplexing arrangements for the mapping of symbols to antennas in MIMO OFDM communications systems;

FIGS. 4a to 4c show, respectively, a known Left-Right/Top-Bottom block interleaver, the 16 QAM constellation, and a diagram illustrating bit allocations for an IEEE 802.11a interleaver for a single OFDM symbol;

FIG. 5 shows one example of a MIMO OFDM interleaving system;

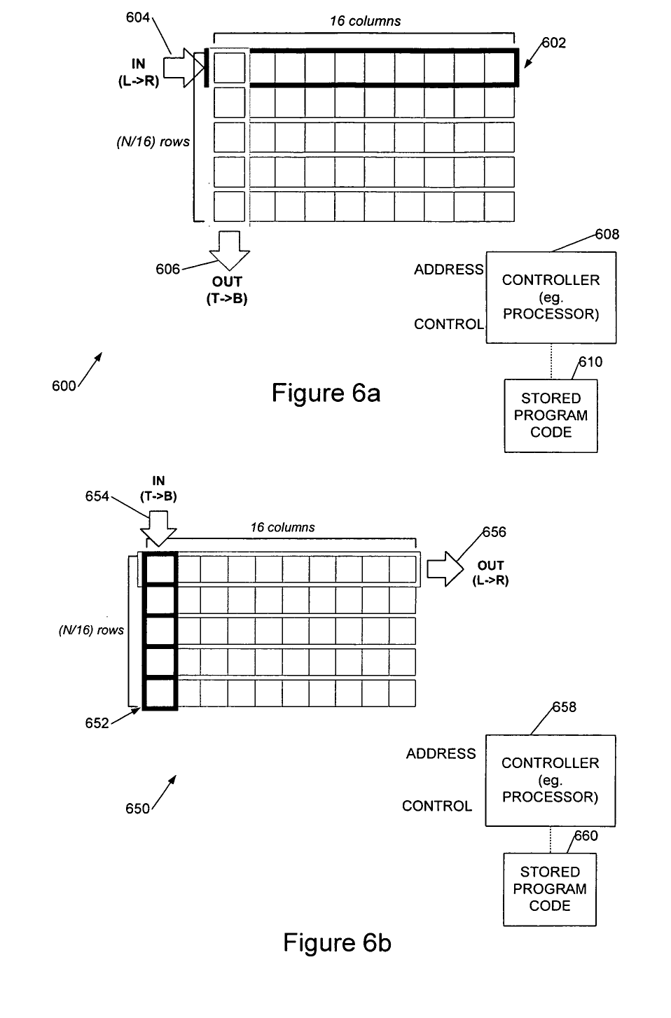

FIG. 6a and 6b show, respectively, structures for implementing a first interleaving stage of an interleaver and for implementing a de-interleaving stage of a de-interleaver according to embodiments of the present invention;

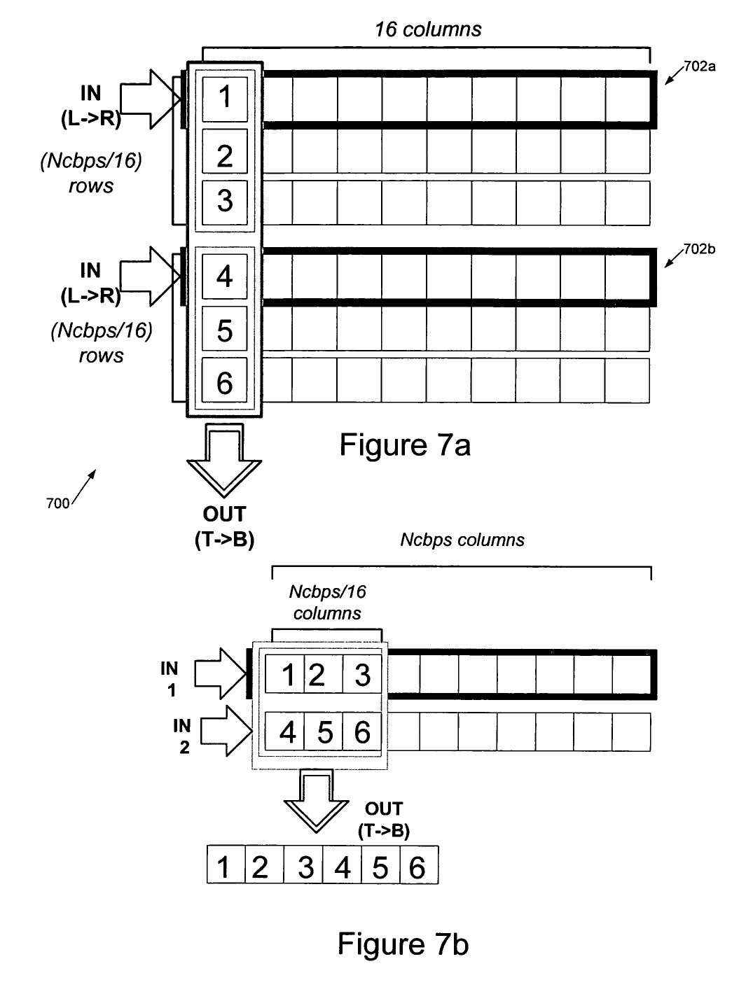

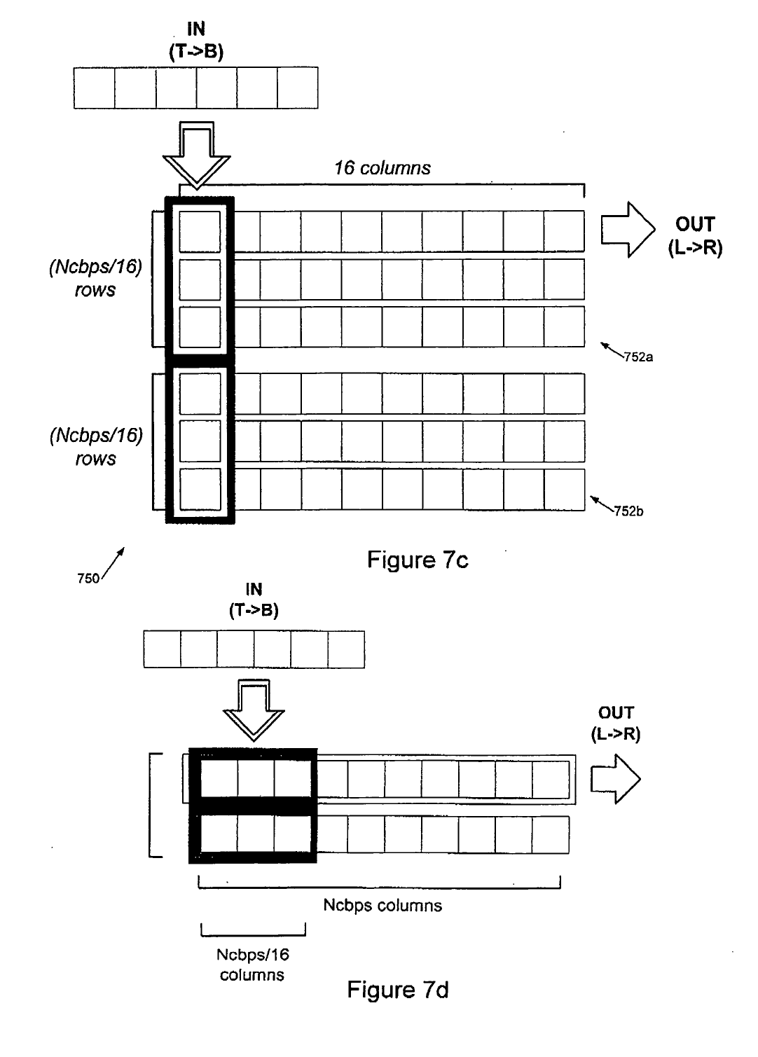

FIGS. 7a to 7d show, respectively, first and second alternative first interleaving stage structures of interleaver and complementary de-interleaving structures according to embodiments of the present invention;

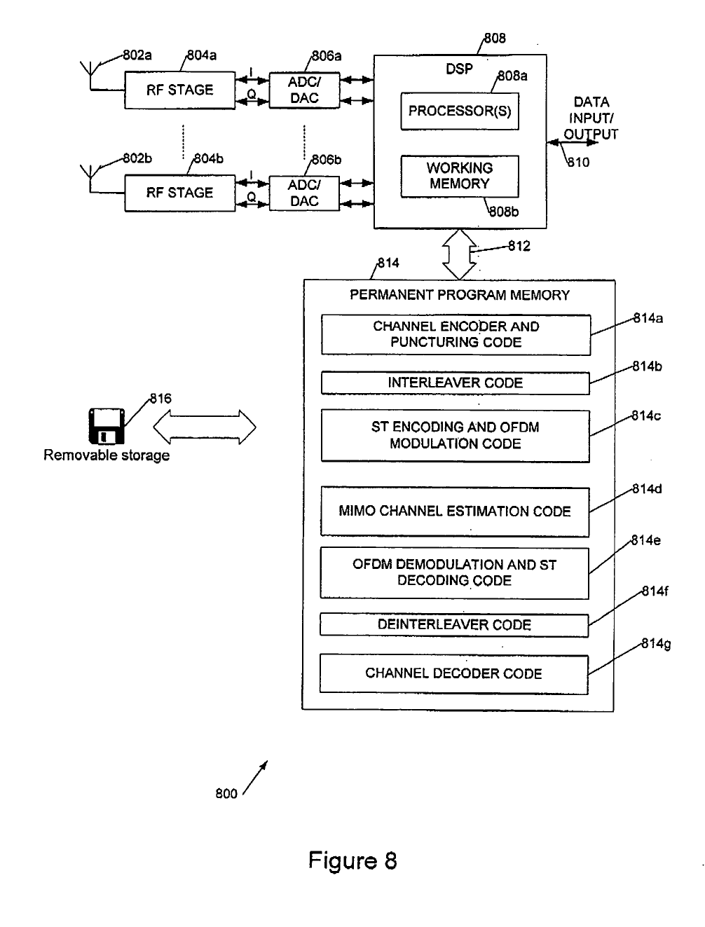

FIG. 8 shows a transceiver 800 incorporating an interleaver and de-interleaver according to embodiments of the present invention; and

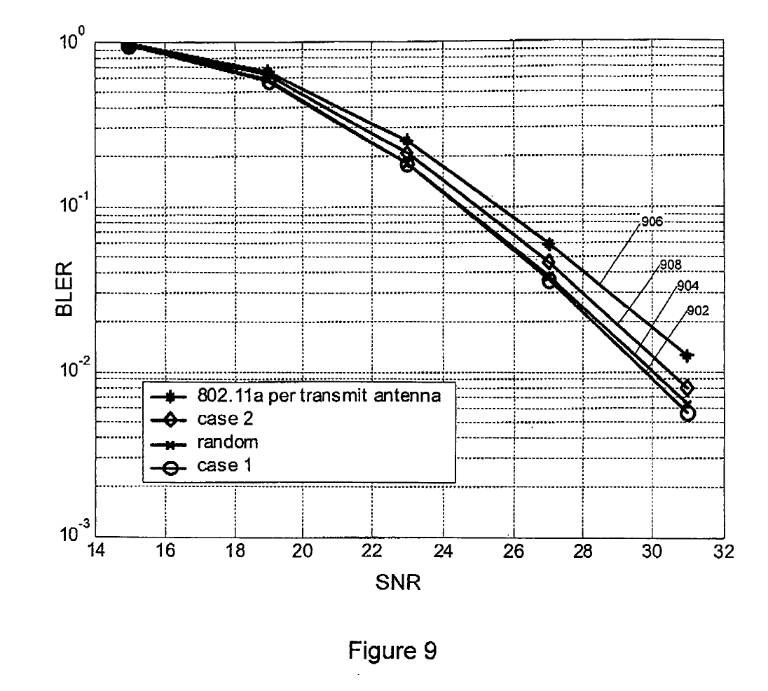

FIG. 9 shows curves of Block Error Rate (BLER) against signal to noise ratio per receive antenna (SNR) for MIMO communications systems with different interleavers/de-interleavers, including an interleaver and de-interleaver according to an embodiment of the present invention.

We will first describe preferred embodiments of an interleaver, and then describe corresponding de-interleavers. The interleaver embodiments we will describe first are implemented as two-stage methods/devices but, as we describe later, the interleaving performed by the two stages in combination may be implemented using a single, unified look-up table (LUT). Whether the stages are combined or not has implications for the hardware (or processor control code) employed—depending upon the interleaving performed by each stage it can be advantageous to implement the interleaving stages separately and, in particular, one advantage of embodiments of the inventions is that they permit re-use of existing 802.11a hardware/procedures will little modification.

We first describe the first interleaving stage of a two-stage interleaving method.

In one embodiment this is defined by the rule (permutation):
π(i)=(N/16)(i mod 16)+floor(i/16)
where i=0 . . . N−1 is the position of the input bit and π(i) is its position after the permutation and floor(parameter) is the largest integer not exceeding the parameter.

Here N is the number of length of the whole block—for example, for two transmit antennas and spatial-multiplexing (i.e. symbols are directly mapped to both antennas without any space-time symbol processing and/or adding new symbols) N is equal to 2*Ncbps.

This stage of the modified 802.11a interleaver is equivalent to a process operating on a 2-D interleaving matrix with N/16 rows and 16 columns and can be rewritten in mathematical terms:
π(i)=(16·i) mod (N−1), i=0 . . . N−1, π(N−1)=N−1
where i is the position of the input bit. This position is multiplied by 16. The result is then divided by (N−1) and the resulting remainder is the new bit position π(i). This is equivalent to taking every 16^{th} bit and placing them to adjacent positions.

Referring to FIG. 6a, this shows the structure of an interleaver 600 configured to implement a first interleaving stage using the above rule (permutation). Interleaver 600 comprises a 2D matrix 602, which may be conveniently implemented in a matrix memory block, the matrix having 16 columns and N/16 rows. The matrix has a data input 604, to receive data bits for interleaving, and a data output for reading interleaved data bits from the matrix memory block. There is also an associated controller 608 to provide address and control signals (such as read/write and data strobes) to the matrix memory block to control the writing of data into the matrix (left to right) and the reading of data from the memory (top to bottom) to perform the interleaving function (or, in similar de-interleaver, a de-interleaving function). Controller 608 may be implemented using an ASIC or FPGA, for example by means of a state machine, or by means of a processor under control of stored program code 610.

FIG. 6b shows the structure of a de-interleaver 650 which, as can be seen, is similar to that of the interleaver, comprising a matrix memory storing a matrix of data bits 652, an input 654 to the matrix, an output 656 from the matrix and a controller 658, optionally under the control of stored code 660. The de-interleaver operates in a complementary manner to the interleaver and thus a de-interleaving procedure is followed to load-in the bits received from the Space-Time decoder and read-out the bits. More particularly, instead of a Left-Right/Top-Bottom write/read procedure the bits are written in from Top to Bottom, column after column and read-out from Left to Right, row after row. Thus, the de-interleaving matrix 652 has the same dimensions as the interleaving matrix 602 and only the loading/reading procedure need be different. For this reason a de-interleaver and an interleaver may conveniently be implemented together, using shared hardware resources, if desired.

Alternatively an interleaver (and de-interleaver) may be implemented using a look-up table, in effect hard-wired logic.

In an alternative, preferred embodiment the first interleaving stage is implemented using an 802.11a resource. In embodiments it is possible to use only one instance of an 802.11a first stage to implement the first stage of the present interleaver.

Referring to FIG. 7a, this shows the structure of an interleaver 700 configured to implement a first interleaving stage using a plurality of 802.11a block interleaver matrix instances 702a,b (for clarity the controller is not shown).

The first stage of a conventional 802.11a interleaver is performed for each block of Ncbps bits by means of separate interleavers 702a,b, as described above with reference to FIG. 5. This implements interleaving across frequency (subcarriers). Thus the input data is written into matrices in a left-to-right fashion, loading matrix 702a first and then, after matrix 702a has been filled, loading matrix 702b and so forth (for clarity only two block interleaving matrices are shown but it will be appreciated that more may be implemented as needed). When the data is read out from matrices 702a,b however it is read out column-by-column of the concatenated matrices, as shown—thus, in effect, the columns of the matrices are concatenated to interleave across antennas to form the interleaved bitstream. More generally a function concatenates the parallel blocks of (Ncbps/16) bits to achieve interleaving across antennas; when utilizing space-time multiplexing, for example, the number of the blocks may be equal to the number of antennas.

FIG. 7b again shows another structure of an interleaver 750 configured to implement a first interleaving stage using a plurality of 802.11a interleaver instances 752a,b. In FIG. 7b the 802.11a interleaver instances 752a,b provide an interleaved bit vector output rather than access to an interleaver matrix, but otherwise the operation of the interleaving scheme corresponds to that described above with reference to FIG. 7a.

With the above described methods of implementing the first stage of the present interleaver it is possible to use an 802.11a resource only once for each antenna. This reduces hardware complexity, since it is only necessary to implement one 802.11a first interleaver stage and a concatenation function, and improved performance as compared with the technique described in FIG. 5, because the interleaver interleaves across antennas as well as across frequency

We next describe the second interleaving stage of the two-stage interleaving method.

In a preferred embodiment this is defined by the rule (permutation):
π(i)=s*floor(i/s)+(i+N−floor(16*i/N)) mod s
where i=0 . . . N−1 is the position of the input bit and π(i) is its position after the permutation. Here s is selected dependent upon the constellation size, preferably in the same way as in a conventional 802.11a interleaving scheme as described above (in particular, 3 for 64-QAM, 2 for 16-QAM, 1 for either QPSK or BPSK).

In this second interleaving stage, the bitstream is processed in groups of s bits and a cyclical bit shift is performed (per group), having a shift step=t mod s bits (t=0 . . . 15, increasing by 1 in every N/16 bits). This is similar to the second stage of a conventional 802.11a interleaver, except that the variability of t across the bit stream is different since N defines the length of a block of bits to be multiplexed across (preferably all) the antennas.

To implement a complete interleaver a first interleaving stage as described above (in either of the two basic versions) is followed by a second interleaving stage as described above.

In some implementations the two interleaving stages may be unified into a single Look-Up Table. Then the first described embodiment of the first interleaving stage may be employed in conjunction with the second interleaving stage as the second described embodiment of the first interleaving stage does not lend itself to LUT-based implementation (because the intention there is to reduce complexity by employing existing 802.11a hardware and/or code).

However a single look-up table interleaver may be used for each antenna separately, for example to implement both the first and second 802.11a interleaving stages for each antenna separately, and then the procedure/structure of FIG. 7a or FIG. 7b may then be employed in order to interleave the bits across space. This two step process has been found to be broadly equivalent in performance and complexity to performing the separate 802.11a interleaving and concatenation for the first stage followed by the above-described second stage.

Where “multiplexed” mapping of ST-encoded symbols to antennas is employed (as shown in FIGS. 3a and 3c) embodiments of the above described interleavers map consecutive input bits onto different sub-carriers, symbol bit positions, and transmit antennas. More particularly embodiments as described above map adjacent bits to every third sub-carrier, to different bit positions in the constellation, and also across antennas. This results in improved throughput performance in a communications MIMO system. Moreover at least some embodiments of the interleavers have a relatively low complexity because their structure depends on a common hardware resource (the 802.11a interleaver).

We next describe corresponding de-interleaving methods and de-interleaver architectures. Broadly speaking these are complementary to those described above and will therefore be more briefly described. Again the de-interleavers operate upon a block of data bits N comprising data transmitted by all the transmit antennas, “multiplexed” mapping of ST-encoded symbols to antennas being assumed for the purposes of the discussion.

Thus in de-interleaving at the receiver, the inverse process of interleaving is performed, that is:
π⁻¹(i)=s*floor(i/s)+(i+floor(16*i/N)) mod s, i=0 . . . N−1

This stage is the inverse of the second interleaving stage.

The inverse of the first interleaving stage is then performed. When the first described embodiment of the first interleaving stage has been employed a suitable de-interleaving operation is:
π⁻¹(i)=16*i−(N−1)*floor(16*i/N), i=0 . . . N−1

This step corresponds to implementing a TB/LR (Top-Bottom/Left-Right) block de-interleaver, TB/LR describing the way the bits are written into and read from matrix during the operation of the interleaver. Thus, referring again to FIG. 6b, the de-interleaving matrix 652 is a 2-D matrix with N/16 rows and 16 columns. The structure of the de-interleaver is essentially the same as that of the interleaver of FIG. 6a, although in operation bits are written-in as columns of matrix 652 and read-out as rows. This enables a single hardware resource for both interleaving and de-interleaving, only the loading/read-out procedure being different.

When the second described embodiment (which concatenates 802.11a resources) of the first interleaving stage is employed, the de-interleaving inverse of this stage is complementary to that previously described, except that the bits are input from top to bottom (concatenating the several 802.11a resources vertically) and read-out from left to right, row after row. This is shown in FIGS. 7c and 7d.

Thus, referring to FIG. 7c, this shows the structure of a de-interleaver 750 configured to implement the inverse of a first interleaving stage using a plurality of 802.11a block interleaver matrix instances 752a,b (for clarity the controller is not shown). The structure of FIG. 7d is similar but operates on a bit vector rather than on a matrix.

FIG. 8 shows a transceiver 800 incorporating an interleaver and de-interleaver as described above.

Transceiver 800 comprises a plurality of transceive antennas 802a,b (of which two are shown in the illustrated embodiment) each coupled to a respective transmit/receive RF stage 804a,b (duplexers not shown for clarity of illustration), and thence to respective analogue-to-digital/digital-to-analogue converters 806a,b and to a digital signal processor (DSP) 808. DSP 808 will typically include one or more processors 808a and some working memory 808b. The DSP 808 has a data input/output 810 and an address, data and control bus 812 to couple the DSP to permanent program memory 814 such as flash RAM or ROM. Permanent program memory 814 stores code and optionally data structures or data structure definitions for DSP 808.

As illustrated program memory 814 includes channel encoder and puncturing code 814a, interleaver code 814b, ST encoding and OFDM modulation code 814c, MIMO channel estimation code 814d, OFDM demodulation and ST decoding code 814e, deinterleaver code 814f, and channel decoder code 814g. Depending upon the implementation the interleaver (and de-interleaver) code may simply comprise an interface to an 802.11a hardware resource followed by concatenation code to perform concatenation as described above. Optionally the code in permanent program memory 814 may be provided on a carrier such as an optical or electrical signal carrier or, as illustrated in FIG. 8, a disk 816.

The data input/output 810 of DSP 808 couples to further data processing elements of receiver 800 (not shown in FIG. 8) as desired. These may comprise, for example, a baseband data processor for implementing higher level protocols.

The transmitter rf output stage and receiver front-end will generally be implemented in hardware whilst the receiver processing will usually be implemented at least partially in software, although one or more ASICs and/or FPGAs may also be employed. The skilled person will recognise that all the functions of the receiver could be performed in hardware and that the exact point at which the signal is digitised in a software radio will generally depend upon a cost/complexity/power consumption trade-off.

FIG. 9 shows curves of Block Error Rate (BLER) against signal to noise ratio per receive antenna (SNR) for a MIMO communications system, comparing four different types of interleaver (and de-interleaver): an interleaver as described above according to an embodiment of the present invention (curve 908), a random interleaver (curve 904), an interleaver as shown in FIG. 5 with one 802.11a interleaver applied separately to a bit stream for each antenna (curve 906), and a further alternative interleaving scheme (curve 902) as described in the Applicant's co-pending UK patent application no. ______, entitled “Interleaver and de-interleaver systems” and filed on the same day as this application.

The curves of FIG. 9 were determined show the probability of a block error in a block of 2298 information bits before convolutional encoding and space-time encoding. The simulation parameters were as follows:
3×3 MIMO system (3 transmit and 3 receive antennas)
OFDM transmission of 48 subcarriers
a ST-code as described in UK patent application no. 0410644.9 filed by the present Applicant on 12 May 2004 (TRLP107)
64 QAM modulation
convolutional code of ⅔ coderate, as specified in the 802.11a standard
a 802.11n MIMO non-line of sight (NLOS) channel model (model ‘B’), as specified in the draft standard 802.11n. This is a multipath correlated MIMO channel, simulating real MIMO physical channel conditions.

All interleavers assume the “multiplexing” mapping from ST-coded symbols to antennas shown in FIGS. 3a and 3c.

A random interleaver is a structure which performs random permutations of the input bits. The permutations are different for every block transmitted, that is the permutations generated during each block of transmitted bits changes with every block and is pseudo-random (based on random numbers generated from a pseudo-random source such as a computer program). The random interleaver is not a realistic hardware resource but is a reference benchmark for research on interleavers, because of its performance: Interleavers that challenge the random interleaver in performance, deliver a performance that is close to optimal.

It can be seen that the interleaver of curve 908 has a performance close to that of a random interleaver (as does the interleaver of curve 902). It can also be seen that the interleaver of curve 908 (and of curve 902) outperforms the 802.11a interleaver by 1.5 to 2 dB, thereby demonstrating the improved performance of interleavers embodying aspects of the present invention.

The above described interleaving and de-interleaving systems can be incorporated into the transmitter 100a and receiver 100b of FIG. 1 respectively. It will be appreciated that in many circumstances, a wireless communications device will be provided with the facilities of a transmitter and a receiver in combination, but for the example of FIG. 1 the devices have been illustrated as one-way communications devices for reasons of clarity.

It will be appreciated that a general purpose transmitter or general purpose receiver can be configured to implement an embodiment of the present invention by the introduction of suitable software to be executed by a computer apparatus. To that end, an aspect of the invention comprises a product, storing computer executable instructions in a computer readable form, which in use causes a computer with suitably configurable hardware components, to operate substantially in accordance with the invention as exemplified by the described embodiment. The product may comprise a storage medium such as an optical disk, a magnetic storage medium or a storage medium of any other technology, an active component such as a removable ROM unit or other memory device such as a memory card, or may comprise a signal such as could be received in a download, the signal bearing data defining such computer readable instructions as to establish a computer executable program product. The product may also comprise an application specific integrated circuit which, when installed in a suitably configured general purpose device, renders the resultant system operable in accordance with any of the aspects of the invention exemplified by the described embodiments.

Embodiments of the invention provide low complexity interleavers and have application in wireless local area network (WLAN) communications systems such as IEEE802.11n, and in other MIMO communications systems, in particular those using convolutional channel coding.

The scope of protection claimed in the appended claims is to be determined on the basis of the description, with reference to the accompanying drawings, but not to the extent that features of the specific embodiments of the invention are to be construed as limitations on the scope of features of the claims.

1. An interleaver for a MIMO OFDM communications system having a plurality of transmit antennas, said interleaver being configured to interleave a block of N data bits comprising data for a plurality of OFDM symbols, each OFDM symbol being defined by a block of N_{cbps} bits, by implementing first and second interleaving functions wherein at least one of said interleaving finctions is configured to interleave data bits between said blocks of N_{cbps} bits.

2. An interleaver as claimed in claim 1 wherein said first interleaving function is configured to interleave said block of N data bits such that pairs of bits c bits apart, where c is greater than one, are mapped to adjacent bits.

3. An interleaver as claimed in claim 2 wherein c=16.

4. An interleaver as claimed in claim 1 wherein said first interleaving function comprises a permutation function:
π(i)=(N/16)(i mod 16)+floor (i/16)
Where i denotes an input bit position and π(i) denotes the bit position after an interleaving operation with said permutation function.

5. An interleaver as claimed in claim 1 further comprising a matrix memory block configured to store an interleaving matrix having a plurality of columns and rows sufficient to store said N bits, and a controller to control writing of said N bits into said matrix row-by-row and reading of interleaved data from said matrix column-by-column.

6. An interleaver as claimed in claim 1 wherein said first interleaving function comprises a first stage interleaving within each said block of N_{cbps} bits and a second stage interleaving between said blocks of N_{cbps} bits.

7. An interleaver as claimed in claim 6 wherein said first stage interleaving comprises interleaving according to the first permutation of the interleaving scheme defined in the IEEE 802.11a standard of 1999.

8. An interleaver as claimed in claim 1 wherein said first interleaving function includes a permutation:
π(i)=(N_{cbps}/16)(i mod 16)+floor(i/16)
Where i denotes an input bit position and π(i) denotes the bit position after an interleaving operation with said permutation function.

9. An interleaver as claimed in claim 1 further comprising matrix memory configured to store a plurality of interleaving matrices, one for each said block of N_{cbps} bits, and a controller to control writing of each said block of N_{cbps} bits into a respective interleaving matrix on a row-by-row basis and to control reading of interleaved blocks of N_{cbps} bits from respective interleaving matrices on a column-by-column basis.

10. An interleaver as claimed in claim 9 further comprising a concatenator to concatenate corresponding columns of bits read from said respective interleaving matrices.

11. An interleaver as claimed in claim 1 comprising a plurality of 802.11a interleave each configured to interleave data bits for one of said transmit antennas.

12. An interleaver as claimed in claim 11 further comprising a concatenator to concatenate sets of interleaved bits output from said 802.11a interleavers, each said set of bits comprising N_{cbps}/16 bits successively output from a said 802.11a interleaver.

13. An interleaver as claimed in claim 1 wherein said second interleaving function comprises a permutation over all said N data bits.

14. An interleaver as claimed in claim 13 wherein said permutation includes a bit shift dependent upon a parameter to which varies across said block, changing every N/c bits where c is a positive integer.

15. An interleaver as claimed in claim 14 wherein c=16.

16. An interleaver as claimed in claim 1, wherein said second interleaving function includes a permutation:
π(i)=s*floor (i/s)+(i+N−floor (16*i/N)) mod s
where i denotes an input bit position and π(i) denotes the bit position after an interleaving operation with said permutation function, and s is a positive integer determined by a constellation size of said MIMO OFDM communications system.

17. An interleaver as claimed in claim 1 configured to implement said first and second interleaving functions in separate, successive interleaving stages.

18. An interleaver as claimed in claim 1 further comprising a lookup table configured to implement both said first and said second interleaving functions.

19. An interleaver as claimed in claim 1 wherein said first interleaving function comprises interleaving within each said block of N_{cbps} bits and wherein said second interleaving function comprises interleaving between said blocks of N_{cbps} bits.

20. An interleaver as claimed in claim 19 wherein said first stage interleaving comprises interleaving according to the first and second permutations of the interleaving scheme defined in the IEEE 802.11a standard of 1999.

21. An interleaver as claimed in claim 20 further comprising a lookup table configured to implement said first interleaving function.

22. An interleaver as claimed in claim 21 further comprising a combiner to combine data from said first interleaving function to provide said second interleaving function.

23. Processor control code to, when running, implement the interleaver of any preceding claim.

24. A carrier carrying the processor control code of claim 23.

25. A transmitter including the interleaver of claim 1.

26. A method of interleaving data for a MIMO OFDM communications system having a plurality of transmit antennas, the method comprising:
inputting a block of N data bits comprising data for a plurality of OFDM symbols, each OFDM symbol being defined by a block of N_{cbps} bits;
implementing a first interleaving function on said block of N data bits;
implementing a second interleaving function on said block of N data bits; and
outputting data interleaved by said first and second interleaving functions;
wherein at least one of said interleaving functions is configured to interleave data bits between said blocks of N_{cbps} bits.

27. A method as claimed in claim 26 wherein said first interleaving function comprises interleaving across subcarriers of a said OFDM symbol followed by interleaving across said antennas.

28. A method as claimed in claim 26 wherein said first interleaving function comprises separate interleaving for signals for each said transit antenna, and wherein said second interleaving function comprises interleaving across said transmit antennas.

29. A method as claimed in claims 27 wherein said first interleaving function comprises one or both interleaving permutations defined in the IEEE 802.11a Standard 1999.

30. A method as claimed in claim 26 wherein said second interleaving function comprises a permutation over all said N data bits.

31. A method as claimed in claim 26 wherein one or both of said first and second interleaving functions are implemented using a single lookup table.

32. Processor control code to, when running, implement the interleaver of any one of claims 26 to 31.

33. A carrier carrying the processor control code of claim 32.

34. An interleaver for a MIMO OFDM communications system having a plurality of transmit antennas, the interleaver comprising:
means for inputting a block of N data bits comprising data for a plurality of OFDM symbols, each OFDM symbol being defined by a block of N_{cbps} bits;
means for implementing a first interleaving function on said block of N data bits;
means for implementing a second interleaving function on said block of N data bits;
means for outputting data interleaved by said first and second interleaving functions; and
wherein at least one of said interleaving functions is configured to interleave data bits between said blocks of N_{cbps} bits.

35. A de-interleaver comprising means for de-interleaving data interleaved by the interleaver of claim 1.

36. A de-interleaver for a MIMO OFDM communications system having a plurality of transmit antennas, said de-interleaver being configured to de-interleave N interleaved data bits comprising data for a plurality of transmitted OFDM symbols, each OFDM symbol being defined by N_{cbps} interleaved bits, by implementing second and first de-interleaving functions, wherein at least one of said de-interleaving functions is configured to de-interleave data permuted across said N data bits to provide a plurality of blocks of N_{cbps} bits each corresponding to a said OFDM symbol.

37. A de-interleaver as claimed in claim 36 wherein said first de-interleaving function is configured to map adjacent bits of said N interleaved bits received from different ones of said transmit antennas to pairs of bits c bits apart, where c is greater than one.

38. A de-interleaver as claimed in claim 36 wherein said first de-interleaving function includes a permutation:
π⁻¹(i)=16*i−(N−1)*floor(16*i/N)
where i denotes an input bit position and π⁻¹(i) denotes the bit position after de-interleaving with the permutation.

39. A de-interleaver as claimed in claim 36 wherein said first de-interleaving function comprises de-interleaving to provide said plurality of blocks of N_{cbps} bits followed by de-interleaving of each said block N_{cbps} bits.

40. A de-interleaver as claimed in claim 39 wherein said de-interleaving of a said block of N_{cbps} bits includes at least one de-interleaving permutation according to the IEEE 802.11a standard of 1999.

41. A de-interleaver as claimed in claim 36 wherein said second de-interleaving function includes a permutation over all said N data bits.

42. A de-interleaver as claimed in claim 41 wherein said second de-interleaving function includes a permutation:
π⁻¹(i)=s*floor(i/s)+(i+floor(16*i/N)) mod s
where i denotes an input bit position and π⁻¹(i) denotes the bit position after de-interleaving with the permutation and s is a positive integer determined by a constellation size of said MIMO OFDM communications system.

43. A de-interleaver as claimed in claim 36 further comprising a lookup table configured to implement both of said second and first de-interleaving functions.

44. A de-interleaver as claimed in claim 36 wherein said second de-interleaving function comprises a de-interleaving function to recover blocks of N_{cbps} bits, each block corresponding to a said OFDM symbol.

45. A de-interleaver as claimed in claim 44 wherein said first de-interleaving function comprises a function to separately de-interleave each said block of N_{cbps} bits.

46. Processor control code to, when running, implement the interleaver of any one of claims 36 to 45.

47. A carrier carrying the processor control code of claim 46.

48. A method of de-interleaving data in a MIMO OFDM communications system, the method comprising:
inputting N interleaved data bits comprising data for a plurality of transmitted OFDM symbols, each OFDM symbol being defined by N_{cbps} interleaved bits;
implementing a second de-interleaving function on said N data bits;
implementing a first de-interleaving function on said N data bits; and
outputting data de-interleaved by said first and second de-interleaving functions;
wherein at least one of said de-interleaving functions is configured to de-interleave data permuted across said N data bits to provide a plurality of blocks of N_{cbps} bits each corresponding to a said OFDM symbol.

49. A method as claimed in claim 48 wherein said first de-interleaving function comprises de-interleaving across said antennas followed by de-interleaving across subcarriers of a said OFDM symbol.

50. A method as claimed in claim 48 wherein said first de-interleaving function comprises separate de-interleaving for each said transmit antenna, and wherein said second de-interleaving function comprises de-interleaving across said transmit antennas.

51. A method as claimed in claim 49 wherein said first de-interleaving function comprises one or both de-interleaving permutations defined in the IEEE 802.11a standard of 1999.

52. A method as claimed in claim 48 wherein said second de-interleaving function comprises a permutation across all said N data bits.

53. A method as claimed in claim 48 wherein one or both of said first and second de-interleaving functions are implemented using a single lookup table.

54. Processor control code to, when running, implement the interleaver of claim 48.

55. A carrier carrying the processor control code of claim 54.

56. A de-interleaver for de-interleaving data in a MIMO OFDM communications system, the de-interleaver comprising:
means for inputting N interleaved data bits comprising data for a plurality of transmitted OFDM symbols, each OFDM symbol being defined by N_{cbps} interleaved bits;
means for implementing a second de-interleaving function on said N data bits;
means for implementing a first de-interleaving function on said N data bits; and
means for outputting data de-interleaved by said first and second de-interleaving functions;
wherein at least one of said de-interleaving functions is configured to de-interleave data permuted across said N data bits to provide a plurality of blocks of N_{cbps} bits each corresponding to a said OFDM symbol.

57. A MIMO OFDM signal comprising data interleaved by the interleaver of claim 1.
